(19) United States
(12) Patent Application Publication
(10) Pub. No.: US 2022/0076469 A1
(43) Pub. Date: Mar. 10, 2022

(54) INFORMATION DISPLAY DEVICE AND INFORMATION DISPLAY PROGRAM

(71) Applicant: MAXELL, LTD., Kyoto (JP)

(72) Inventor: Kazuhiko YOSHIZAWA, Osaka (JP)

(21) Appl. No.: 17/529,638

(22) Filed: Nov. 18, 2021

Related U.S. Application Data
(63) Continuation of application No. 15/114,992, filed on Jul. 28, 2016, now abandoned.

(51) Int. Cl. G06T 11/60; G06F 16/9537; G06F 3/0481; G06F 3/0346; G01C 21/20

(52) U.S. Cl. CPC G06T 11/60; G06F 16/9537; G06F 2203/04803; G06F 3/0346; G01C 21/20; G06F 3/0481

(57) ABSTRACT

An information display device acquires information about the current location of the device and information about the orientation of the device when the device is directed to a targeted ground object. A map information storage unit stores map information and a target ground object identification execution unit identifies, on a map, the targeted ground object by use of the current location and orientation information. A specific information acquisition unit acquires specific information relating to the target ground object; and a related information acquisition unit acquires related information relating to the targeted ground object by using a search process based on the specific information. The target ground object identification execution unit identifies, from among the ground objects on the map that are located in the direction in which the information display device is directed, the closest ground object to the current location of the information display device on the map.

### TECHNICAL FIELD

The present invention relates to an information display device and an information display program, and more particularly, to a device to display related information of a “targeted ground object”.

### BACKGROUND ART

Navigation systems utilizing a GPS (Global Positioning System) and map information are popularly used. Portable information terminals such as smart phones and tablet-type terminals have a GPS reception function for use of various navigation services.

For example, Patent Literature 1 discloses a portable map display device having: a positional information acquiring device, a position measuring means, a directional information acquiring device, a direction measuring means, a distance information acquiring device, a distance measuring means, and a map information storage means, and further, a target object specifying means to specify the position of an actual targeted object by using information obtained with the respective means. The map display device described in the Patent Literature 1 specifies a ground object on a map corresponding to an actual target ground object, based on the position of the actual target ground object specified by a user with the target object specifying means of the map display device, and displays attribute information on the display device.

Further, Patent Literature 2 discloses a pointing system to process information relating to an object addressed by a user. In the invention in the Patent

Literature 2, when the user directs a hand-held device (portable terminal) to an object to be addressed, the device measures the positon and the attitude of the portable terminal, then searches a database on a network, to determine the addressed object, and information relating to the target object is presented on a user interface.

### CITATION LIST

### Patent Literature

PTL 1: Japanese Patent Application Laid-Open No. 2005-49500

PTL 2: Japanese Patent Application Laid-Open No. 2010-205281

### SUMMARY OF THE INVENTION

### Technical Problems to be Solved by the Invention

The map display device described in the Patent Literature 1 itself has the position measuring means, the direction measuring means, and the display device. The map display device is directed to a targeted ground object, and the positional information and the direction information of the display device itself are acquired. Further, the distance information between the display device and the targeted ground object is acquired with the distance measuring means. The positional information of the targeted ground object is calculated from the acquired various information. Further, the display device is required to acquire attribute information of the targeted ground object and measure the distance between the display device and the targeted ground object with the map display device by referring to map information based on the calculated positional information of the targeted ground object.

Accordingly, when the map display device is used on e.g. a bustling street, there is a possibility that a surging crowd of people and a vehicle sequence between the device and the targeted ground object become obstacles, and it is not possible to correctly acquire the distance information between the map display device and the targeted ground object. That is, on the bustling street or the like, there is a possibility that it is not possible to correctly display the attribute information of the targeted ground object since the surging crowd of people or the like becomes an obstacle. Further, it goes without saying that addition of hardware for acquisition of distance information increases the production cost of the map display device.

Patent Literature 2 discloses a pointing system to address an object and operate information relating to the object with a portable terminal or the like. In the invention in the Patent Literature 2, disclosed is an example where the constituent elements such as position determination means and attitude determination means are not physically confined only in the portable terminal, however they are distributed, along with a database, on a wireless network. In the invention in the Patent Literature 2, a record in the database includes a geometrical descriptor to define discontinuous spatial range. A search means searches the database by determining whether or not address status defined by instant position and instant attitude measured with the portable terminal crosses the spatial range.

In the invention in the Patent Literature 2, geometrical crossing determination of comparing the address status of the portable terminal with the geometrical descriptor of the database records. When crossing is determined, multimedia information of the database record is read. In this invention, as the geometrical crossing determination is performed in space represented with three-dimensional coordinates, determination of attitude of the portable terminal is required in addition to determination of the position of the portable terminal to specify the targeted object. Further, complicated geometrical operation processing based on these information is required.

An object of the present invention is, in view of the above conventional technical problems, to provide an information display device capable of displaying information on a targeted ground object when the display device is directed by a user to the neighboring targeted ground object, with a more simple configuration.

### Solutions to Problems

As a solution to the above problem, an example of the information display device according to the present invention will be described. Provided is an information display device capable of displaying related information of a ground object, including: a location information acquisition unit that acquires current location information of the information display device; an orientation information acquisition unit that acquires orientation information of the information display device when the information display device is directed to a targeted ground object; a map information storage unit that holds map information; a target ground object identification execution unit that identifies the targeted ground object as a target ground object by referring to the map information using the current location information and the orientation information; a specific information acquisition unit that acquires specific information relating to the target ground object; a related information acquisition unit that acquires the related information of the targeted ground object by search processing based on the specific information; and a display unit that displays the related information of the targeted ground object, wherein the target ground object identification execution unit identifies a ground object on a map, intersecting a direction to which the information display device is directed from the current location of the information display device on the map acquired with the map information, in a location closest to the information display device, as the target ground object, based on the current location information and the orientation information of the information display device.

### Advantageous Effects of the Invention

By using the technique of the present invention, it is possible to provide an information display device capable of displaying information on a neighboring targeted ground object with a more simple configuration.

### BRIEF DESCRIPTION OF DRAWINGS

FIG. 1 is a block diagram of an information display device according to a first embodiment of the present invention;

FIG. 2 is a software configuration diagram of the information display device according to the first embodiment.

FIG. 3A is a front external view and FIG. 3B is a rear external view of the information display device according to the first embodiment.

FIG. 4 is a configuration diagram of an information display system including the information display device according to the first embodiment.

FIG. 5 is a screen display view of a basic screen in the information display device according to the first embodiment.

FIG. 6 is a flowchart of an information display operation in the information display device according to the first embodiment.

FIG. 7 is a screen display view of a ground object information display screen (initial status) in the information display device.

FIG. 8 is a screen display view of the ground object display screen (acquiring information) in the information display device.

FIG. 9A is a conceptual diagram explaining target ground object identification processing in the information display device.

FIG. 9B is another conceptual diagram explaining the target ground object identification processing in the information display device.

FIG. 9C is another conceptual diagram explaining the target ground object identification processing in the information display device.

FIG. 10A is a screen display view of the ground object information display screen (result display) in the information display device according to the first embodiment.

FIG. 10B is another screen display view of the ground object information display screen (result display) in the information display device according to the first embodiment.

FIG. 11 is a software configuration diagram of the information display device according to a second embodiment of the present invention.

FIG. 12 is a screen display view of the basic screen in the information display device according to the second embodiment.

FIG. 13 is a flowchart of the information display operation in the information display device according to the second embodiment.

FIG. 14 is a screen display view of a live view display screen in the information display device according to the second embodiment.

FIG. 15 is an enlarged view of a live view window of the information display device according to the second embodiment.

FIG. 16 is a conceptual diagram explaining a gaze mark in the information display device.

FIG. 17A, FIG. 17B and FIG. 17C are conceptual diagrams explaining the shape of the gaze mark in the information display device.

FIG. 18 is a conceptual diagram explaining a related information display window of the information display device.

FIG. 19 is a conceptual diagram explaining a reference marker in the information display device.

FIG. 20 is a conceptual diagram explaining the format of an image data file in the information display device according to the second embodiment.

### DESCRIPTION OF EMBODIMENTS

Hereinbelow, examples of the embodiments according to the present invention will be described in detail using the drawings.

### First Embodiment

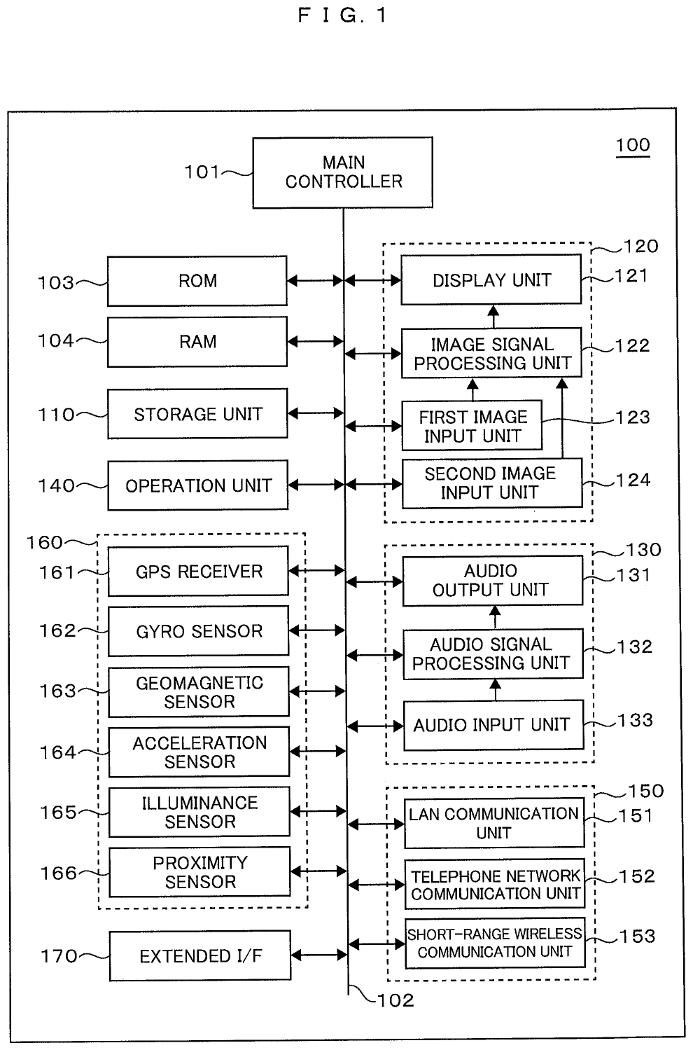

First, a first embodiment of the present invention will be described with reference to FIG. 1 to FIG. 10.

FIG. 1 is a block diagram of an information display device according to the first embodiment. The information display device 100 has a computer having a main controller 101, a system bus 102, a ROM 103, a RAM 104, a storage unit 110, an image processing unit 120, an audio processing unit 130, an operation unit 140, a communication processing unit 150, a sensor unit 160, an extended interface 170, and the like, as constituent elements.

The information display device 100 may be configured with a terminal with a communication function, e.g., a portable terminal such as a mobile phone, a smart phone, or a tablet-type terminal, as a base. It may be configured with a PDA (Personal Digital Assistant) or a notebook-type PC (Personal Computer) as a base. Further, it may be configured with a portable digital device such as a digital still camera or a video camera capable of moving-image shooting, a portable game machine or the like, or another portable digital device, as a base.

The main controller 101 is a microprocessor unit to control the entire information display device 100 in accordance with a predetermined program. The system bus 102 is a data communication path for data transmission/reception between the main controller 101 and the respective elements in the information display device 100.

The ROM (Read Only Memory) 103 is a memory in which a basic operation program such as an operating system and other application programs are stored. For example, a rewritable ROM such as an EEPROM (Electrically Erasable Programmable ROM) or a flash ROM is used. The RAM (Random Access Memory) 104 is a work area upon execution of the basic operation program and other application programs. The ROM 103 and the RAM 104 may be integrally configured with the main controller 101. Further, it may be configured such that as the ROM 103, not an independent element as shown in FIG. 1 but a temporary storage region in the storage unit 110 is used.

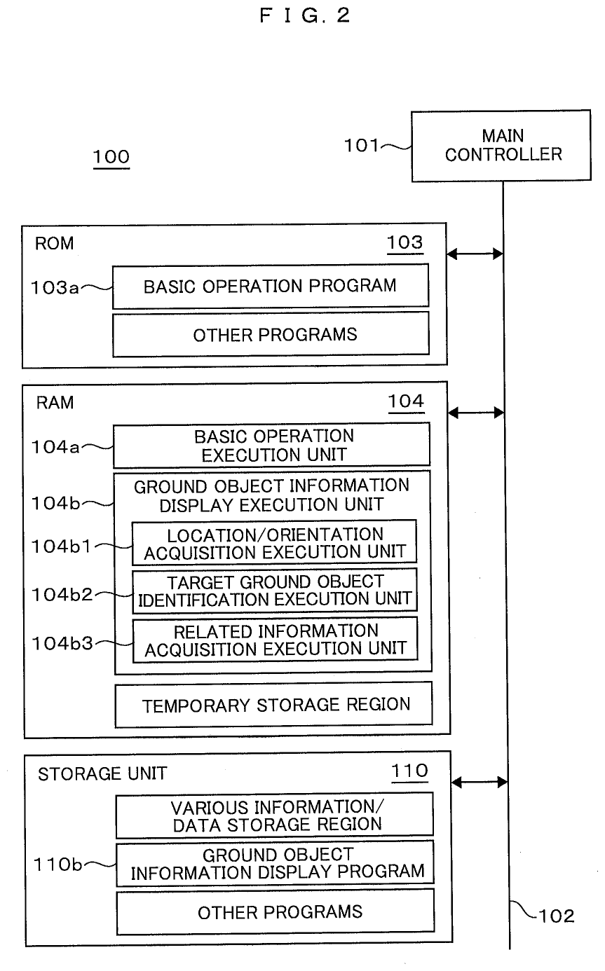

The storage unit 110 holds various operation setting values for the information display device 100, and information of a user of the information display device 100, in a various information/data storage region. The various information/data storage region also functions as a map information storage unit to hold map information group downloaded from a network. Further, it is capable of holding still image data and moving image data and the like obtained by shooting with the information display device 100. Further, the storage unit 110 is also capable of holding new application programs downloaded from the network. One of the application programs is an “information display program” to realize primary functions of the information display device according to the present embodiment. Note that the configuration and function of the “information display program” will be described in detail in FIG. 2 and the subsequent figures.

The entire or a part of the functions of the ROM 103 may be substituted with a partial region of the storage unit 110. Further, the storage unit 110 is required to hold stored information even in a status where the information display device 100 is not power-supplied. Accordingly, a device such as a flash ROM, an SSD (Solid State Drive), or an HDD (Hard Disc Drive) is used.

The image processing unit 120 has a display unit 121, an image signal processing unit 122, a first image input unit 123, and a second image input unit 124. The display unit 121 is a display device such as a liquid crystal panel, and it provides image data processed with the image signal processing unit 122 to the user of the information display device 100. The image signal processing unit 122 has an unshown video RAM. The display unit 121 is driven based on image data inputted in the video RAM. Further, the image signal processing unit 122 has functions to perform format conversion, signal overlay processing with respect to menu or other OSD (On Screen Display) signals in accordance with necessity. The first image input unit 123 and the second image input unit 124 are camera units to input image data of the neighborhood and objects by converting light inputted from a lens to electrical signal using an electronic device such as a CCD (Charge Coupled Device) or a CMOS (Complementary Metal Oxide Semiconductor) sensor.

The audio processing unit 130 has an audio output unit 131, an audio signal processing unit 132, and an audio input unit 133. The audio output unit 131 is a speaker which provides an audio signal processed with the audio signal processing unit 132 to the user of the information display device 100. The audio input unit 133 is a microphone which converts the user's voice or the like into audio data and inputs it to the information display device. Note that it may be configured such that the audio input unit 133 is a separate body from the information display device 100 and it is connected to the information display device 100 by cable communication or wireless communication.

The operation unit 140 is an instruction input unit to input an operation instruction to the information display device 100. In the present embodiment, it is configured with a touch panel 140t overlay-arranged on the display unit 121 and an operation key 140k with arrayed button switches. It may be configured with only one of these units. The information display device 100 may be operated by using a keyboard or the like connected to an extended interface 170 to be described later. The information display device 100 may be operated by using a separate information terminal equipment connected by cable communication or wireless communication. Further, the display unit 121 may have the above touch panel function.

The communication processing unit 150 has a LAN (Local Area Network) communication unit 151, a mobile radiotelephone network communication unit 152, and a short-range wireless communication unit 153. The LAN communication unit 151 is connected to a wireless communication access point 202 of the Internet 201 by wireless communication, and performs data transmission/reception. The mobile radiotelephone network communication unit 152 performs telephone communication (telephone call) and data transmission/reception by wireless communication with a base station 203 of a mobile radiotelephone network. The short-range wireless communication unit 153 performs wireless communication when it is in the vicinity of a corresponding reader/writer. The LAN communication unit 151, the mobile radiotelephone network communication unit 152 and the short-range wireless communication unit 153 respectively have an encoder, a decoder, an antenna and the like. Other communication units such as an infrared communication unit may be further provided.

The sensor unit 160 is a sensor group to detect the status of the information display device 100. In the present embodiment, it has a GPS receiver 161, a gyro sensor 162, a geomagnetic sensor 163, an acceleration sensor 164, an illuminance sensor 165, and a proximity sensor 166. The sensor group forms a location information acquisition unit to acquire current location information of the information display device 100, and an orientation information acquisition unit to acquire orientation information of the information display device when the information display device 100 is directed to a targeted ground object. It is possible to detect the location, inclination, direction, motion, ambient brightness, proximity status of neighboring object, and the like of the information display device 100 with the sensor group including the location information acquisition unit and the orientation information acquisition unit. The information display device 100 may further have other sensors such as an atmospheric pressure sensor.

The extended interface 170 is an interface group to extend the functions of the information display device 100. In the present embodiment, it is configured with an image/audio interface, a USB (Universal Serial Bus) interface, a memory interface and the like. The image/audio interface performs image signal/audio signal input from an external image/audio output device, image signal/audio signal output to the external image/audio input device, and the like. The USB interface establishes connection to a PC for data transmission/reception, and establishes connection to a keyboard and other USB devices. The memory interface establishes connection to the memory card or other memory media for data transmission/reception.

Note that the configuration example of the information display device 100 shown in FIG. 1 includes many constituent elements not indispensable for the present embodiment, such as the audio processing unit 140. Even when the configuration is not provided with these elements, the effect of the present embodiment is not impaired. Further, unshown constituent elements, such as a digital television broadcast reception function or an electronic money settlement function, may be further added.

FIG. 2 is a software configuration diagram of the information display device 100 according to the present embodiment, showing a software configuration in the ROM 103, the RAM 104, and the storage unit 110. In the present embodiment, a basic operation program 103a and other programs are stored in the ROM 103, and a “information display program” 110b and other programs are stored in the storage unit 110.

The basic operation program 103a stored in the ROM 103 is expanded in the RAM 104a. Further, the main controller 101 executes the expanded basic operation program, to form a basic operation execution unit 104a. Further, the “information display program” 110b stored in the storage unit 110 is expanded in the RAM 104. Further, the main controller 101 executes the expanded “information display program”, to form an information display execution unit 104b, a location/orientation acquisition execution unit 104b1, a target ground object identification execution unit 104b2, and a related information acquisition execution unit 104b3. Further, the RAM 104 have a temporary storage region to temporarily hold data in accordance with necessity upon execution of various application programs.

The location/orientation acquisition execution unit 104b1 has the functions of a location information acquisition unit to acquire the current location information of the information display device 100 from GPS information (latitude, longitude and the like) received with the GPS receiver 161, and an orientation information acquisition unit to acquire orientation information of the information display device when the information display device 100 is directed to a targeted ground object from outputs from the gyro sensor 162, the geomagnetic sensor 163 and the like.

The target ground object identification execution unit 104b2 has a function to identify a targeted ground object as a “target ground object” by referring to map information downloaded from the network using location information and orientation information calculated with the location/orientation acquisition execution unit 104b1. When the “target ground object” is e.g. a high-rise building or building complex, one or plural tenants exist in the building.

The related information acquisition execution unit 104b3 has the function of a specific information acquisition unit to refer to downloaded map information and acquire specific information (address information, store name information, building name information and the like) of a ground object as a target (“targeted ground object”) from additional data accompanying the map information, and the function of a related information acquisition unit to perform network search with the specific information of the targeted ground object as keywords and acquire related information relating to the targeted ground object. When the “targeted ground object” as the user's target is correctly identified, it is easy to acquire the information relating to the respective tenants in the “targeted ground object” from websites or map information service applications on the network. With this configuration, the user selects a store name or the like as a target, and acquires the related information relating to the store or the like.

Note that the communication processing unit 150 in FIG. 1 functions as a communication unit for the related information acquisition execution unit 104b3 to transmit the specific information acquired with the specific information acquisition unit to a search server on the network, and to receive the related information from the search server as related information for the related information acquisition unit.

Note that in the following description, for the sake of simplification of the explanation, the processing to control the respective elements, performed with the main controller 101, by expanding the basic operation program 103a stored in the ROM 103, in the RAM 104, and executing the program, will be described as control on the respective elements with the basic operation execution unit 104a. Regarding other application programs, similar description will be made.

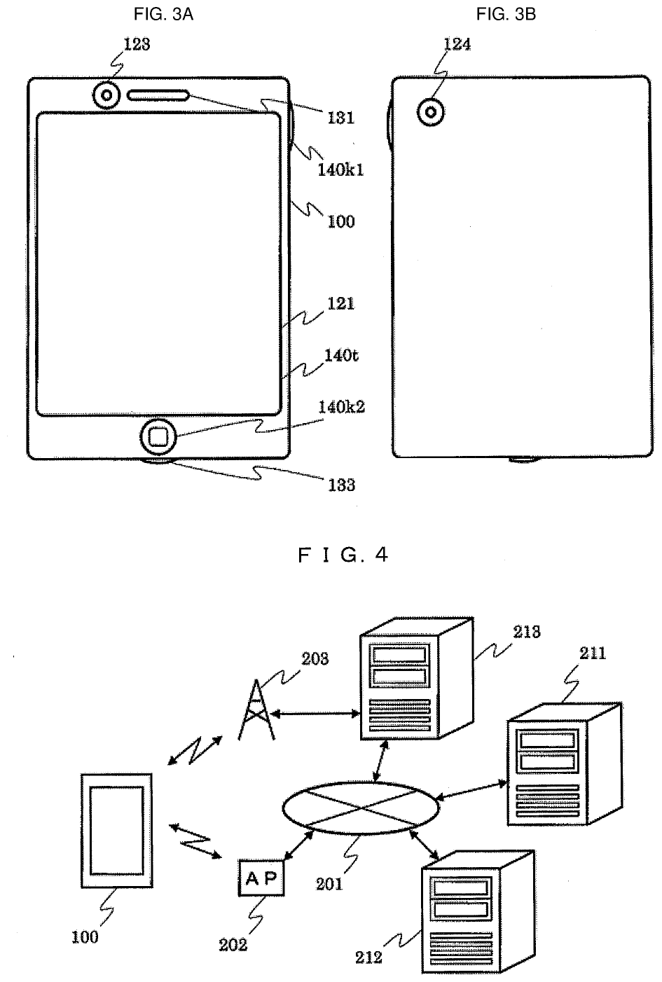

FIG. 3A and FIG. 3B are external views of the information display device 100 according to the present embodiment. Note that the external view is an example when the information display device 100 is an information terminal equipment such as a smart phone. FIG. 3A is a front surface view of the information display device 100; and FIG. 3B, a back surface (rear surface) view of the information display device 100. Regarding right and left side views and top and bottom views, illustration will be omitted. As shown in FIG. 3A, in the present embodiment, the first image input unit 123 is located on the same plane (front surface) as that the display unit 121 is located on, and the second image input unit 124 is located on the opposite plate (back surface) to the display unit 121. In the following description, the first image input unit 123 located on the same plane as that the display unit 121 is located on may be referred to as an “in-camera”, while the second image input unit 124 located on the opposite plane to the display unit 121 as an “out-camera”.

Note that the position of the second image input unit 124 is not necessarily on the back surface as long as it is not on the same plane as that the display unit 121 is located on. Further, it may be configured such that the second image input unit 124 is a separate body from the information display device 100, and it is connected to the information display device 100 by cable communication or wireless communication. Further, only one of the camera units may be provided. Further, the information display device 100 may have a different form, such as a digital still camera, from that in FIGS. 3A and 3B.

FIG. 4 is a configuration diagram of an information display system including the information display device 100 according to the present embodiment. The information display system has the information display device 100, a wide area public network 201 such as the Internet and its wireless communication access point 202, a base station 203 of the mobile radiotelephone communication network, an application server 211, a map data server 212, and a mobile radiotelephone communication server 213. Note that it goes without saying that a large number of unshown various server devices and terminal devices are connected to the Internet 201. Commercially available map information where longitude and latitude on the ground surface are allotted to XY coordinate values on a plane, e.g. Google Maps (registered trademark), is stored in the map data server 212.

In the information display device 100, function extension is possible by downloading new application programs from the application server 211 via the Internet 201 and the wireless communication access point 202 or the base station 203 of the mobile radiotelephone communication network. At this time, the downloaded new application program is stored in the storage unit 110. The information display device 100 is capable of realizing many types of new functions by expanding the new application program stored in the storage unit 110 in the RAM 104 and executing the expanded new application program with the main controller 101.

Further, it is possible to perform version up and function extension of the basic operation program and the other application programs by updating the program stored in the ROM 103 with the downloaded application program.

According to the present embodiment, the information display device 100 is configured on the assumption of utilization of cloud computing resources (software and hardware, in other words, their processing functions, storage regions, data and the like) via a network, so-called cloud computing. Accordingly, it is possible to provide an information display device capable of displaying information on a targeted ground object with a simple structure.

In the following description, the operation of the information display device 100 according to the present embodiment will be described. The information display operation in the information display device 100 according to the present embodiment is controlled with the information display execution unit 104b and the location/orientation acquisition execution unit 104b1, the target ground object identification execution unit 104b2, the related information acquisition execution unit 104b3, or the basic operation execution unit 104a, which are formed by expansion of the information display program 110b stored in the storage unit 110, in the RAM 104, and execution of the information display program with the main controller 101, as shown in FIG. 2.

Otherwise, it may be configured such that the information display device 100 according to the present embodiment further has respective hardware blocks to realize the above-described information display execution unit 104b, the location/orientation acquisition execution unit 104b1, the target ground object identification execution unit 102, and the related information acquisition execution unit 104b3 with hardware, and that the respective hardware blocks, substituting for the information display execution unit 104b, the location/orientation acquisition execution unit 104b1, the target ground object identification execution unit 104b2, and the related information acquisition execution unit 104b3, control the operation of the information display device 100. The location/orientation acquisition execution unit 104b1 of the information display device 100 acquires map information around the current location from the map data server 212 by utilizing the GPS information (latitude, longitude and the like) received with the GPS receiver 161, and displays the current location and its neighborhood on a map on the display unit 121.

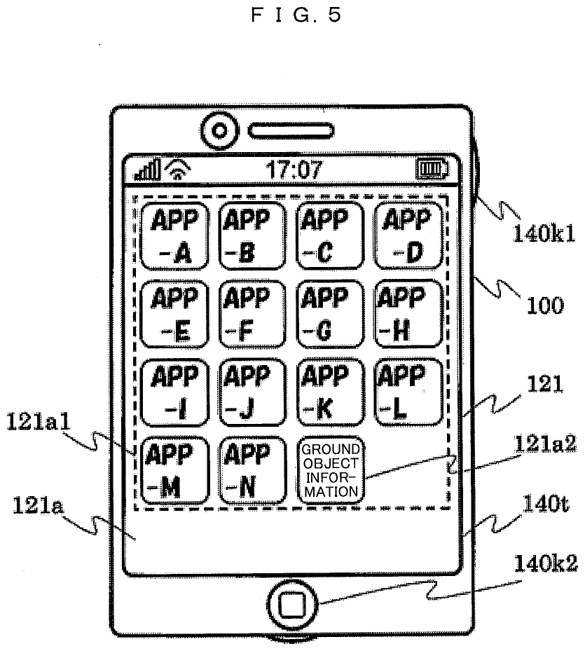

FIG. 5 is a screen display view explaining the basic screen 121a displayed on the display unit 121 of the information display device 100. The basic screen 121a is displayed when the power source of the information display device 100 is turned ON by depression of a power source key 140k1, or a home key 140k2 is depressed during execution of an arbitrary application program. An icon group (APP-A to N, “ground object information”) displayed in a region 121a1 of the basic screen 121a is a group of icons associated with various application programs executable with the information display device 100. In particular, a “ground object information” icon 121a2 is associated with the “information display program” to execute the information display processing as a feature of the information display device 100 according to the present embodiment. By selecting any icon APP, a predetermined application program associated with the selected icon is executed.

Note that the selection of icon may be performed by tap operation in a predetermined region on the touch panel 140t corresponding to the position where a targeted icon is displayed on the display unit 121. Otherwise, it may be performed by operating operation keys such as an unshown cross-shaped cursor key and an enter key. It may be configured such that the gaze of the user of the information display device 100 is detected by using the first image input unit 123, and the selection of icon is performed based on the detected gaze information.

In the information display device 100 that operates under the control of the basic operation execution unit 104a, when the user selects the icon 121a2 on the basic screen 121a by tap operation or the like, the “information display program” is executed, then the basic operation execution unit 104a starts the information display execution unit 104b, and assigns the control main body to the information display execution unit 104b.

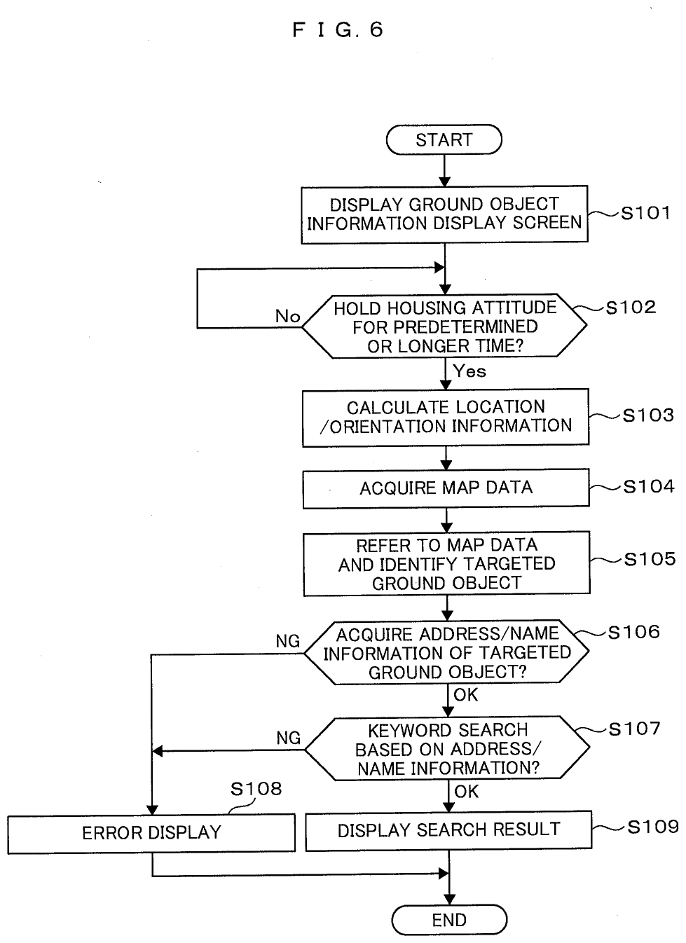

Hereinbelow, an example of the information display operation under the control of the information display execution unit 104b accompanying the starting of the “information display program” will be described using the flowchart of FIG. 6.

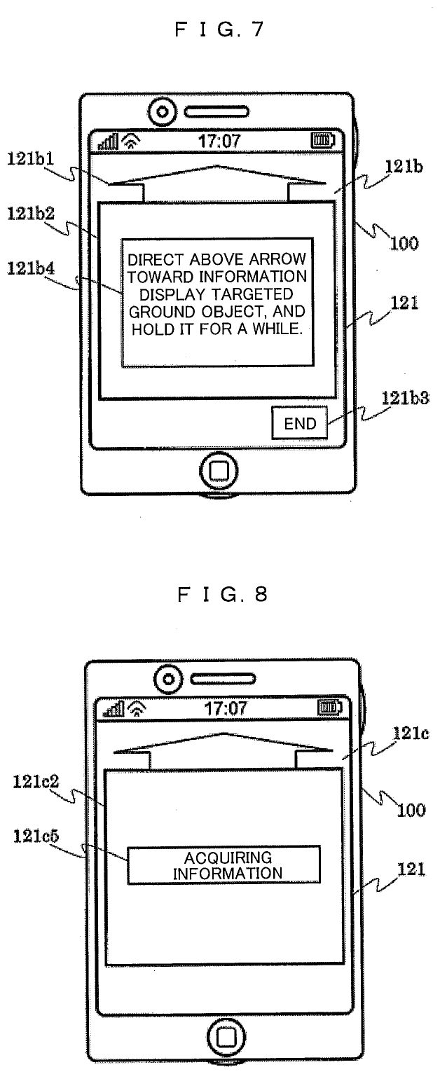

The information display execution unit 104b, assigned with control main body from the basic operation execution unit 104a, first displays a ground object information display screen (initial status) 121b, an example of which is as shown in FIG. 7 (S101). The ground object information display screen (initial status) 121b has a navigation mark 121b1 such as an “arrow”, an information display region 121b2, and an “end” icon 121b3. Further, a guide display 121b4 is displayed in the information display region 121b2. As the guide display 121b4, guidance e.g. “Direct above arrow to direction of information display object and hold it for a while.” is presented. Otherwise, guidance “Direct arrow to direction of object while stand still.” may be presented. When the user selects the “end” icon 121b3, or depresses the home key 140k2 (illustration is omitted in the flowchart of FIG. 6), the information display execution unit 104b returns the control main body to the basic operation execution unit 104a, and terminates the operation of the information display execution unit 104b. Further, the basic operation execution unit 104a displays the basic screen 121a.

Meanwhile, when the information display processing is continued, the user controls the housing attitude of the information display device 100 such that the end side of the arrow of the navigation mark 121b1 is directed to the ground object of which information is to be acquired (hereinbelow, referred to as a targeted ground object), in accordance with the guidance of the guide display 121b4. That is, for example, when the user finds a store the detailed information on which is to be acquired while walking on a shopping street, the user holds the information display device 100 with the arrow of the navigation mark 121b1 directed to the target store. Further, in the status where the arrow of the navigation mark 121b1 is directed to the target store, it is determined whether or not the user has held the housing attitude of the information display device 100 for a predetermined or longer period of time (S102: Yes). The predetermined period of time may be a time length to determine with the information display device 100 whether or not the user has intentionally held the attitude. For example, as the predetermined time, 0.5 seconds or 1 second is previously set.

In the information display device 100 according to the present embodiment, in the processing at S102, when it is determined that the housing attitude has been held for the predetermined or longer period of time, the processing at S103 and the subsequent steps is started. That is, when it is not determined that the housing attitude has been held for the predetermined or longer period of time, e.g., when the user has continuously moved the housing (S102: No), the processing at S103 and the subsequent steps is not started.

Note that the status where the housing attitude is held means a status where the spatial position of the housing is approximately fixed. Note that it is not necessary that the spatial position of the housing is completely fixed, but slight positional change due to handshake or the like is allowed, and it is determined that the housing attitude is held.

Otherwise, it may be configured such that the processing of determination of “housing attitude” at S102 is omitted, and with selection of “information acquisition” icon (not shown) additionally provided in the ground object information display screen (initial status) 121b as a trigger, the processing at S103 and the subsequent steps is started.

In the processing at S102, when it is determined that the housing attitude has been held for the predetermined or longer period of time, the information display execution unit 104b changes the display on the display unit 121 to a ground object information display screen (acquiring information) 121c an example of which is as shown in FIG. 8. In the ground object information display screen (acquiring information) 121c, a message 121c5 is displayed in an information display region 121c2. Further, under the control of the information display execution unit 104b, the location/orientation acquisition execution unit 104b1 calculates location information of the information display device 100 from a signal received with the GPS receiver 161, and calculates orientation information of the information display device 100 from outputs from the gyro sensor 162, the geomagnetic sensor 163 and the like (S103).

Note that the calculation of location information and orientation information using the GPS receiver 161, the gyro sensor 162, the geomagnetic sensor 163 and the like may be performed using a known technique. Accordingly, the detailed explanation will be omitted here. The calculation of location information and orientation information may be performed without the GPS receiver 161, the gyro sensor 162, the geomagnetic sensor 163 and the like.

Next, the information display execution unit 104b downloads map information of the current location of the information display device 100 and its neighborhood from the map data server 212 via the Internet 201 and the LAN communication unit 151 or the mobile radiotelephone network communication unit 152, based on the location information calculated with the location/orientation acquisition execution unit 104b1 in the processing at S103, and stores it in the temporary storage region of the RAM 104 (S104). It may be configured such that map data group is previously downloaded from the map data server 212 in the various information/data storage region of the storage unit 110, and the map data of the current location of the information display device 100 and its neighborhood from the downloaded map data group is loaded in the temporary storage region of the RAM 104.

Next, under the control of the information display execution unit 104b, the target ground object identification execution unit 104b2 performs target ground object identification processing to identify the targeted ground object, i.e., the ground object to which the user has directed the end side of the arrow of the navigation mark 121b1, by referring to the map data downloaded from the map data server 212 and stored in the temporary storage region of the RAM 104 in the processing at S104, using the location information and orientation information calculated with the location/orientation acquisition execution unit 104b1 in the processing at S103 (S105).

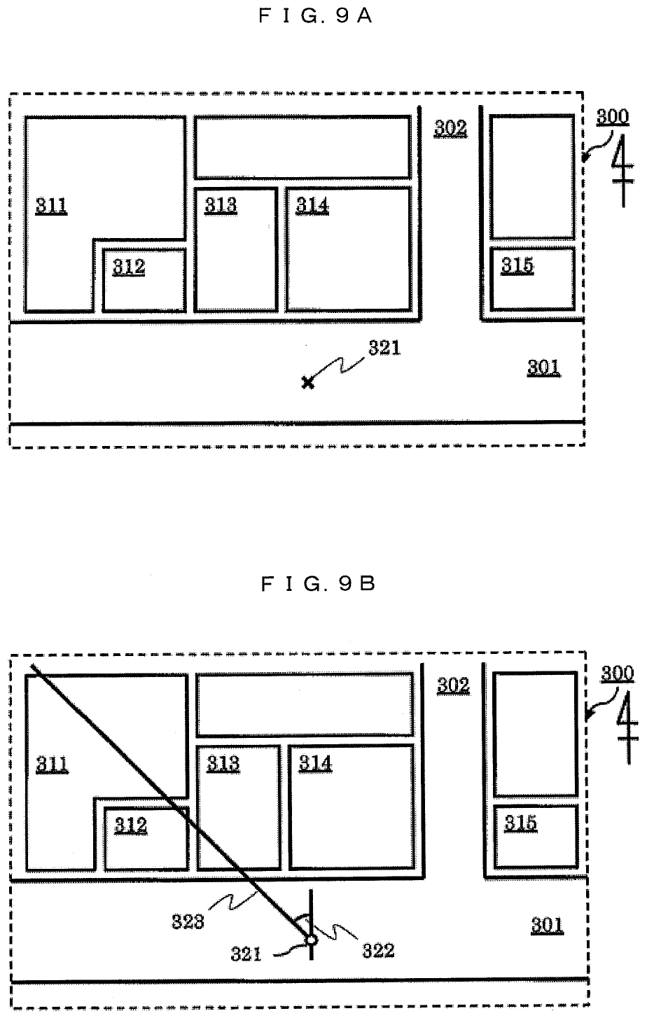

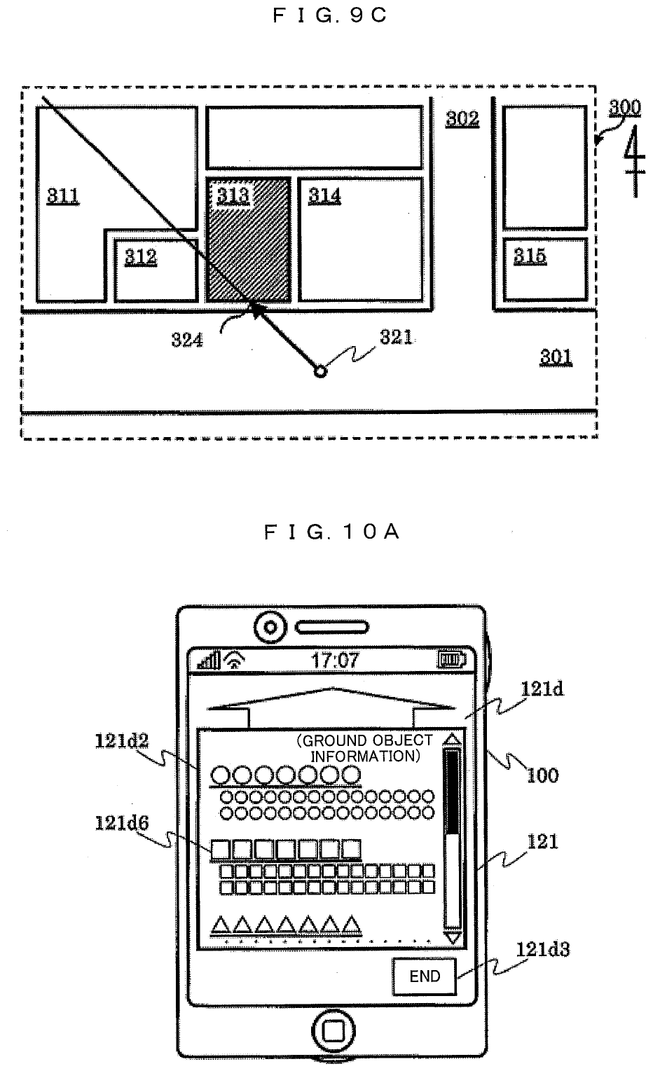

An example of the target ground object identification processing at S105 will be described using FIG. 9A to FIG. 9C.

Note that in the present embodiment, it is assumed that in the actual space, the user having the information display device 100 is located around a T-intersection where a highway 301 and a side street 302 intersect, in a shopping street where stores 311 to 315 and the like are arrayed.

In the target ground object identification processing according to the present embodiment, first, a current location 321 of the information display device 100 based on the location information calculated in the processing at S103 is determined on map data 300 downloaded in the processing at S104 (FIG. 9A).

FIG. 9A shows the user current location 321 based on the location information calculated with the location/orientation acquisition execution unit 104b1 and the map data 300 downloaded from the map data server 212 and stored in the temporary storage region of the RAM 104, overlay-displayed on a common two-dimensional coordinate plane, in the target ground object identification processing at S105. The displayed two-dimensional map data 300 includes the user current location 321, the target ground object to which the user directs the information display device 100 and its peripheral buildings (the stores 311 to 315 and the like), and peripheral roads (the highway 301 and the side street 302). As a matter of course, the target ground object and its peripheral buildings displayed on the two-dimensional coordinate plane are displayed as plane figures uniformly indicating their outer contours (locations) viewed from the sky regardless of their height, the number of hierarchical layers, and inner structure. Regarding the roads, they are also displayed as plane figures viewed from the sky. The map data may be three-dimensional data for which GPS is available as long as the outer contour (location) information of the ground object is acquired.

Next, a straight line 323 is drawn from the current location 321 of the information display device 100 on the map data 300 in the direction at an angle (azimuth) 322 indicated with the orientation information calculated in the processing at S103 (FIG. 9B). Note that in the present embodiment, North is set as angle reference, however, another orientation may be set as the angle reference. Further, among ground objects which the straight line 323 intersects (the stores 311 to 313 and the like in FIG. 9B), a ground object (the store 313) in a closest location (intersection 324) from the current location 321 of the information display device 100 is identified as the targeted ground object (FIG. 9C). Since the straight line 323 along which the user directs the information display device and the ground object are on the same two-dimensional coordinate plane, the intersecting ground object is easily identified as long as the current location 321 and the azimuth 322 are found.

Note that when the user standing in the current location 321 of the highway 301 gazes at the store 313, it is not probable, as a matter of course, that the user's gaze recognizes the store 312 and the store 311 through the store 313. Accordingly, there is no problem that the ground object (the store 313) in the closest location to the current location 321, among the ground objects intersecting the straight line 323, is determined as the targeted ground object.

Further, in the above description, to facilitate understanding, the algorithm of the target ground object identification processing according to the present embodiment has been explained with graphic depiction using FIG. 9A to FIG. 9C. Actually, it may be configured such that all the processing based on the algorithm are performed by operation on the RAM 104. It may be configured such that a display similar to that shown in FIG. 9A to FIG. 9C is produced on the display unit 121 to cause the user to check whether or not the ground object identified based on the algorithm of the target ground object identification processing according to the present embodiment is the targeted ground object.

According to the above algorithm, distance information between the information display device 100 and the targeted ground object is not required to identify the targeted ground object. Accordingly, hardware and/or software to acquire the distance information is not required. Further, the intersecting ground object is identified by simply obtaining the point 324 at which the outer contour of the ground object and the straight line 323 of the azimuth 322 intersect. The ground object is identified by simple operation processing, and complicated geometrical operation processing is not required.

Note that the targeted ground object as the target of information display for the information display device 100 is a ground object in the vicinity of the user as apparent from FIG. 9A to FIG. 9C. In the embodiment shown in FIG. 9A to FIG. 9C, the user is located on the highway 301 immediately in front of the stores 313 and 314. The user's current location may be anywhere as long as the user gets an unobstructed view of the stores 313, 314 and the like. For example, an environment where the user stands on a sidewalk or at a store opposite to the highway 301 with a car lanes between them, and the user gets an unobstructed view of the stores 313, 314 and the like, may be given. On the other hand, when the user desires to obtain information on another store which is not directly seen from the user's current location 321, e.g., a store behind the store 313, the user may move to the side street 302 and direct the information display device 100 to the store.

When the target ground object identification processing is completed in the processing at S105, the target ground object identification execution unit 104b2, under the control of the information display execution unit 104b, refers to the map data, downloaded from the map data server 212 and stored in the temporary storage region of the RAM 104 in the processing at S104, and acquires specific information (address information, store name information, building name information and the like) of the targeted ground object from additional data accompanying the map data (S106). Next, the information display execution unit 104b transfers the acquired specific information of the targeted ground object to the related information acquisition execution unit 104b3. Further, the related information acquisition execution unit 104b3, under the control of the information display execution unit 104b, performs network search with the specific information of the targeted ground object as keywords, and acquires related information relating to the targeted ground object (S107).

Note that regarding the method for performing network search using specific keyword, a known method/technique may be used. As an example, the specific information of the targeted ground object acquired in the processing at S106 is transmitted via the LAN communication unit 152 or the mobile radiotelephone network communication unit 152 to an unshown search server. The related information relating to the targeted ground object as a result of search is received with the LAN communication unit 151 or the mobile radiotelephone network communication unit 152.

When the specific information of the targeted ground object has not been acquired in the processing at S106, or when the related information relating to the targeted ground object has not been acquired in the processing at S107, the information display execution unit 104b displays an error message indicating that gist on the display unit 121 (S108). Meanwhile, when the specific information of the targeted ground object has been acquired in the processing at S106 and further, the related information relating to the targeted ground object has been acquired in the processing at S107, the information display execution unit 104b displays the acquired related information relating to the targeted ground object on the display unit 121 (S109).

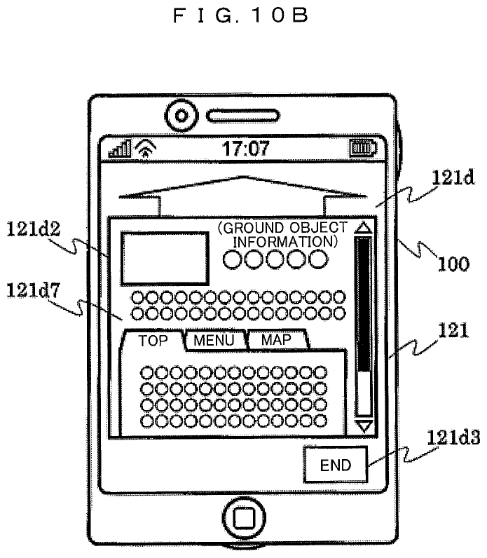

FIG. 10A and FIG. 10B show an example of a screen display view of the ground object information display screen (result display) 121d displayed on the display unit 121 of the information display device 100. In the ground object information display screen (result display) 121d, the related information relating to the targeted ground object acquired by the keyword search performed in the processing at S107 is displayed, in the format of a search result list display 121d6 as shown in FIG. 10A or in the format of a homepage display 121d7 as shown in FIG. 10B, in an information display region 121d2.

The search result list display 121d6 is a format to display a list of link information to plural homepages and the like, which the search engine of the related information acquisition execution unit 104b3 has determined that they match the conditions of the keywords in the keyword search performed in the processing at S107. In this case, it is possible to simply display information on the homepage or the like as the related information of the targeted ground object on the display unit 121 by the user's selecting one of link information to the plural homepages and the like displayed in the list.

The homepage display 121d7 is a format to directly display one of the information on the homepages and the like which the search engine of the related information acquisition execution unit 104b3 has determined that they match the conditions of the keywords in the keyword search performed in the processing at S107. In this case, the user can instantly check the information on the homepage or the like as the related information of the targeted ground object.

Note that it may be configured such that the user sets the form to display the related information of the targeted ground object on the ground object information display screen (result display) 121d of the information display device 100 according to the present embodiment. Otherwise, it may be configured such that when the number of search results, with degree of coincidence with the keyword equal to or higher than a predetermined value, is one, the related information of the targeted ground object is displayed in the homepage display format, while when there are plural search results with degree of coincidence with the keyword is equal to or higher than a predetermined value, the related information relating to the targeted ground object is displayed in the list format. Further, the related information of the targeted ground object may be displayed on the display unit 121 in a different format from the above formats.

Further, it may be configured such that when the specific information of the targeted ground object is acquired in the processing at S106, the specific information of adjacent ground objects (in the example shown in FIG. 9C, the store 312 and the store 314), adjacent to the targeted ground object, is also acquired, and further, the related information relating to the adjacent ground objects is also acquired in the processing at S107. Otherwise, it may be configured such that in the processing at S106 and S107, the related information relating to the respective ground objects located around the targeted ground object is acquired as much as possible within an allowable range of the processing performance of the information display terminal 100.

For example, in some cases, when the housing attitude of the information display device 100 is held in the processing at S102, the arrow of the navigation mark 121b1 is not correctly directed to the targeted ground object (store 313) due to shift of holding angle of the information display device 100. As a result, information different from the related information relating to the targeted ground object (e.g., related information relating to the store 312) is displayed in the processing at S109. In such case, when the related information relating to the adjacent ground objects is previously acquired, as described above, it is possible to quickly change the display of information different from the related information relating to the targeted ground object, displayed on the ground object information display screen (result display) 121d, to the related information relating to the targeted ground object, by left/right direction flick operation or the like on the ground object information display screen (result display) 121d shown in FIG. 10A and FIG. 10B, which further improves the usability.

Further, according to the above processing, even when the user who has checked the related information relating to the targeted ground object desires to check the information on the adjacent ground objects in sequence, the user can immediately check it.

Note that in the above first embodiment, the user's current location 321 is described as a fixed point, however, under a predetermined condition, it may be a moving point including at least two different points. In the display screen of FIG. 7, as the user is not required to “stop”, the user may operate the device while move. Even when the user is walking or on a low-speed moving body and the user's current location 321 changes in time, the map display device according to the present embodiment is available. During the user's moving, the azimuth between the user and the targeted ground object 313 continuously changes slightly. However, information necessary within predetermined time is only the information on the current location and the azimuth of the information display terminal 100. As long as the user intentionally directs the information display device 100 to the particular targeted ground object 313 during this time, the location closest to the straight line at each time point within the predetermined time (intersection 324) is on the contour line of the targeted ground object 313. When the straight line extending from each current location of the walking user intersects only the contour line of a particular ground object on the map, it may be determined that the spatial position of the housing (absolute position) is fixed.

As described above, in the information display device 100 according to the present embodiment, it is possible to provide an information display device and a method capable of displaying information on a targeted ground object in the vicinity of the user with more simple configuration. That is, as the information display device 100 effectively utilizes cloud computing resources, it is possible to acquire and display related information of the targeted ground object with a more simple configuration without hardware and/or software to acquire distance information between the information display device 100 and the targeted ground object to identify the targeted ground object.

Further, the related information of the targeted ground object is acquired from a public network such as the Internet by network search with the specific information (address information, store name information, building name information and the like) of the targeted ground object as keywords. Accordingly, it is possible to efficiently collect latest information.

Further, the intersecting ground object is identified only by obtaining a point at which the contour line of the ground object and the straight line indicating the direction of the information display device intersect on map data e.g. a two-dimensional coordinate plane. It is possible to perform the identification with simple operation processing. In the present embodiment, information necessary for determination of housing attitude is the current position and the azimuth of the information display terminal itself in the actual space. In the actual space, even when people, vehicles and the like exist between the information display terminal and a targeted ground object, there is no problem. Even when the map display device according to the present embodiment is used in an environment such as a bustling street where may buildings and stores are arrayed and many people, vehicles and the like frequently move between the user and a targeted ground object, it is possible to appropriately present and display information on a neighboring targeted ground object to the user.

Further, it is possible to easily realize the information display device according to the present embodiment only by downloading the “information display program” as an application program to a commercially available portable terminal having a communication function.

### Second Embodiment

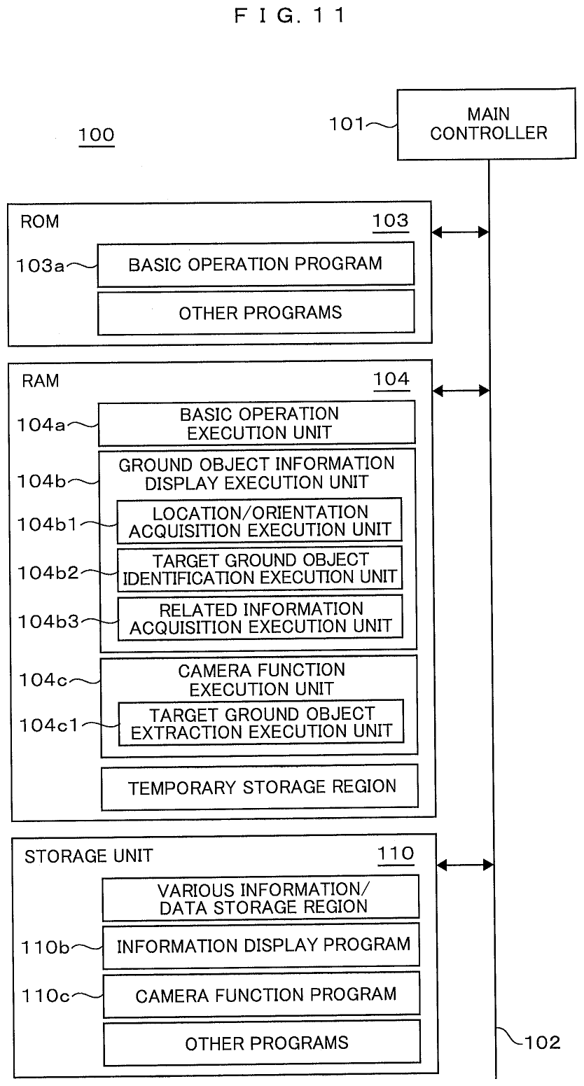

In the following description, a second embodiment of the present invention will be described with reference to FIG. 11 to FIG. 20. Note that the characteristic constituent elements and effects and the like of the present embodiment are the same as those of the first embodiment unless otherwise noted. Accordingly, in the following description, the difference between the present embodiment and the first embodiment will be mainly described, but explanations of corresponding points are omitted as much as possible to avoid redundancy.

FIG. 11 is a software configuration diagram of the information display device 100 according to the present embodiment.

In the present embodiment, the information display program 110b, a camera function program 110c and other programs are stored in the storage unit 110. That is, in the second embodiment, a digital camera is used as a particular example of the portable terminal. In addition to the configuration of the first embodiment, the camera function program 110c is provided.

As in the case of the first embodiment, the information display program 110b stored in the storage unit 110 is expanded in the RAM 104. Further, the main controller 101 executes the expanded information display program, to form the information display execution unit 104b, the location/orientation acquisition execution unit 104b1, the target ground object identification execution unit 104b2, and the related information acquisition execution unit 104b3. Further, the camera function program 110c is expanded in the RAM 104. Further, the main controller 101 executes the expanded camera function program 110c, to form a camera function execution unit 104c and a target ground object extraction execution unit 104c1.

The information display operation of the information display device 100 according to the present embodiment is mainly controlled with the information display execution unit 104b, the location/orientation acquisition execution unit 104b1, the target ground object identification execution unit 104b2, the related information acquisition execution unit 104b3, the basic operation execution unit 104a, and the camera function execution unit 104c and the target ground object extraction execution unit 104c1.

Otherwise, it may be configured such that the information display device 100 according to the present embodiment further has respective hardware blocks to realize, with hardware, operations equivalent to the above information display execution unit 104b, the location/orientation acquisition execution unit 104b1, the target ground object identification execution unit 104b2, the related information acquisition execution unit 104b3, the camera function execution unit 104c, and the target ground object extraction execution unit 104c1, and the respective hardware blocks substituting for the information display execution unit 104b, the location/orientation acquisition execution unit 104b1, the target ground object identification execution unit 104b2, the related information acquisition execution unit 104b3, the camera function execution unit 104c, and the target ground object extraction execution unit 104c1, control the operation of the information display device 100.

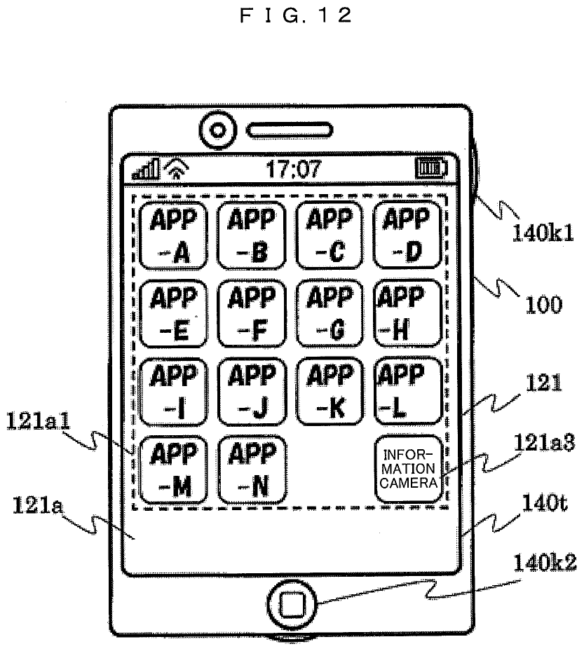

FIG. 12 is a screen display view explaining the basic screen 121a of the information display device 100 according to the present embodiment. An icon group (APP-A to N) displayed in the region 121a1 of the basic screen 121a is a group of icons associated with respective application programs executable with the information display device 100. Further, an “information camera” icon 121a3 is an icon associated with the “information display program” to execute information display processing as a feature of the information display device 100 according to the present embodiment. In the information display device 100 operating under the control of the basic operation execution unit 104a, when the user selects the icon 121a3 on the basic screen 121a by tap operation or the like, the basic operation execution unit 104a starts the information display execution unit 104b of the “information display program”, and assigns the control main body to the information display execution unit 104b.

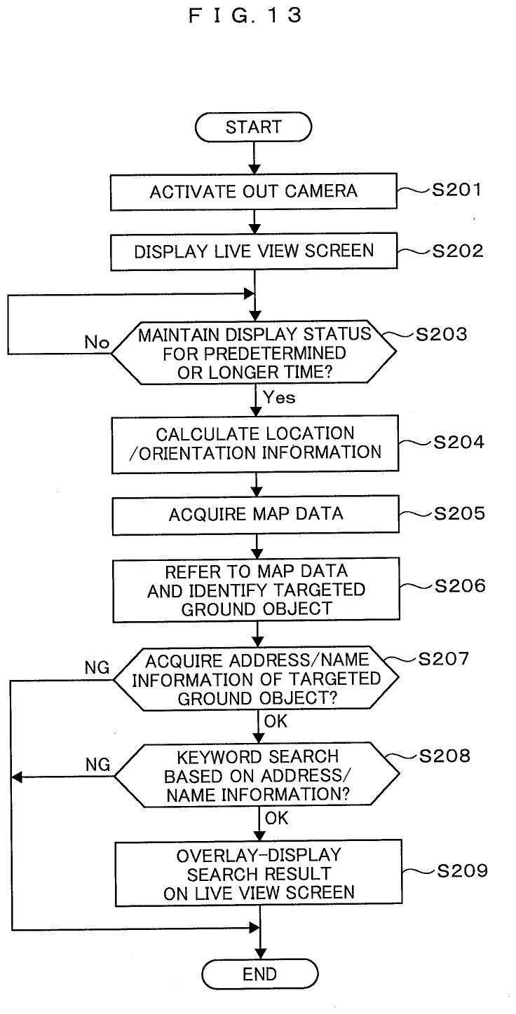

Hereinbelow, an example of the information display operation under the control of the information display execution unit 104b will be described using the flowchart of FIG. 13.

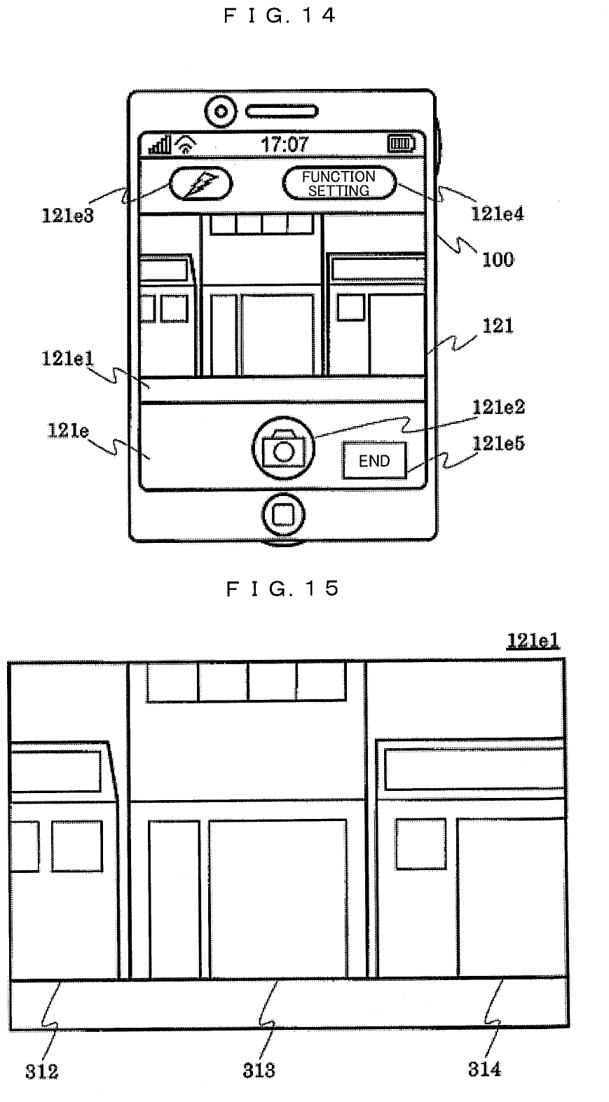

The information display execution unit 104b, assigned with the control main body from the basic operation execution unit 104a, first, starts the camera function execution unit 104c and activates the second image input unit 124 (out-camera) (S201). Next, under the control of the information display execution unit 104b, the camera function execution unit 104c starts image input from the second image input unit 124, and displays the input image data on a live view display screen 121e, an example of which is as shown in FIG. 14 (S202).

The live view display screen 121e is formed with a live view window 121e1, a “shutter” icon 121e2, a “flash” icon 121e3, a “function setting” icon 121e4, and an “end” icon 121e5.

The live view window 121e1 displays the image data inputted with the second image input unit 124. The user of the information display device 100 can control compositional arrangement and the like of objects to be subjected to shooting while check the display on the live view window 121e1. Note that zoom in/out with the second image input unit 124 is controlled by an operation such as pinch out/in and the like on the touch panel 140t (see FIG. 12) corresponding to a position on the display unit 121 where the live view window 121e1 is displayed.

When it is detected that the user has selected the “shutter” icon 121e2, the camera function execution unit 104c starts a recording sequence. In the recording sequence, the camera function execution unit 104c performs, image data input from the second image input unit 124 by executing, in addition to focusing, exposure and the like, processing to e.g. convert output from an electronic device such as a CCD/CMOS sensor into digital image data. Further, the camera function execution unit 104c performs signal processing such as gamma correction, noise elimination and the like on the input image data, and stores the image data subjected to the respective processings into the various information/data storage region of the storage unit 110.

The “flash” icon 121e3, when selected, enables/disables the flash function. The “function setting” icon 121e4, when selected, enables change of various settings of the camera function of the information display device 100 according to the present embodiment.

Note that as the signal processing such as focusing, exposure, gamma correction and noise elimination, the flash function, and the various setting change function are not constituent elements as characteristic features of the present invention, but known techniques may be used, the detailed explanations of the functions will be omitted.

When the user has selected the “end” icon 121e5, or has depressed the home key 140k2 (though it is unshown in the flowchart of FIG. 13), the information display execution unit 104b terminates the operation of the camera function execution unit 104c and disables the second image input unit 124, returns the control main body to the basic operation execution unit 104a, and terminates the operation of the information display execution unit 104b. Further, the basic operation execution unit 104a displays the basic screen 121a.

When the information display processing is continued, the user controls the housing attitude of the information display device 100 to enable shooting with respect to a ground object information of which is to be acquired (targeted ground object) with the second image input unit 124. That is, e.g., when the user finds a store the detailed information of which is to be acquired while walking on a shopping street, the user may hold the information display device 100 with the second image input unit 124 directed to the targeted store, such that the target store is displayed on the live view window 121e1 of the live view display screen 121e. Further, the user holds the housing attitude of the information display terminal 100 for a predetermined or longer period of time in the status where the target store is displayed on the live view window 121e1 (S203: Yes).

In the information display terminal 100 according to the present embodiment, in the processing at S203, when it is determined that the housing attitude has been held for the predetermined or longer period of time, processing at S204 and the subsequent steps is started. That is, when it is not determined that the housing attitude has been held for the predetermined or longer period of time (S203: No) since e.g. the image displayed on the live view window 121e1 has continuously changed, the processing at S204 and the subsequent steps is not started. Note that the above status where the housing attitude is held means a status where the spatial position of the housing is approximately fixed. Note that the spatial position of the housing is not necessarily fixed, but slight positional change due to handshake is allowed, and it is determined that the housing attitude is held. Otherwise, it may be configured such that with selection of “information acquisition” icon (not shown) additionally provided in the live view display screen 121e as a trigger, the processing at S204 and the subsequent steps is started.

In the processing at S203, when it is determined that the status where the targeted ground object (target store) is displayed on the live view window 121e1 has been held for a predetermined or longer period of time, the information display execution unit 104b performs processing at S204 to S208. The processing is the same as the processing at S103 to S107 according to the first embodiment, accordingly, explanations of the processing will be omitted. Note that regarding the orientation information acquired in the processing at S204, it goes without saying that in comparison with the case of the first embodiment, it is necessary to appropriately perform correction considering that the second image input unit 124 is directed to the targeted ground object.

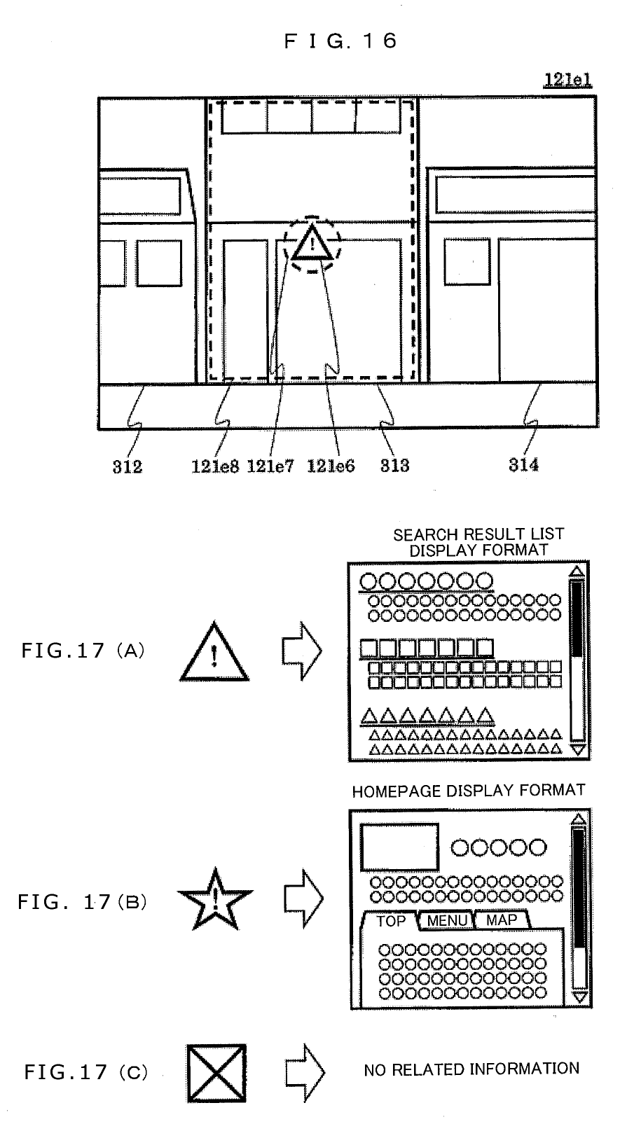

When the specific information of the targeted ground object is acquired in the processing at S207, and further, the related information relating to the targeted ground object is acquired in the processing at S208, the camera function execution unit 104c, under the control of the information display execution unit 104b, overlay-displays a gaze mark (see FIG. 16: 121e6), indicating that there is displayable related information relating to the targeted ground object, in a position in the live view window 121e1 where the relevance to the targeted ground object is clear (S209). On the other hand, when the specific information of the targeted ground object is not acquired in the processing at S207, or when the related information relating to the targeted ground object is not acquired in the processing at S208, the overlay processing is not performed.

FIG. 15 is an enlarged view of the live view window 121e1 in the live view display screen 121e. It shows an example where the user holds the information display device 100 with the second image input unit 124 directed to the store 313 on the current location 321 on the map shown in FIG. 9. In this case, the store 313 at the center and the adjacent stores 312 and 314 are shot and displayed on the live view window 121e1.

In the display status, when the user has held the housing attitude of the information display terminal 100 for the predetermined or longer period of time, and acquired the related information relating to the store 313, as shown in FIG. 16, the gaze mark 121e6 is overlay-displayed in a position in the live view window 121e1 where the relevance to the store 313 is clear. Note that in FIG. 16, as a display position of the gaze mark 121e6 where the relevance to the store 313 is clear, a position around the center of the store 313 in the live view window is selected. As a display position of the gaze mark 121e6 where the relevance to the store 313 is clear, not only the position around the center of the store 313 in the live view window but e.g. an arbitrary position overlapping the store 313 may also be selected.

Further, it may be configured such that when the user selects a predetermined region 121e7 on the touch panel 140t, corresponding to the position on the display unit 121 where the gaze mark 121e6 is displayed in the live view window 121e1, by a tap operation or the like, the related information relating to the store 313 acquired in the processing at S208 is displayed on the display unit 121 in the format of the search result list display 121d6 shown in FIG. 10A or in the format of the homepage display 121d7 shown in FIG. 10B. Otherwise, it may be configured such that when the tap operation or the like is performed on a region 121e8 indicating the store 313, extracted with the target ground object extraction execution unit 104c1 from image data inputted from the second image input unit 124 and displayed on the live view window 121e1, the related information relating to the store 313 acquired in the processing at S208 is displayed.

Further, it may be configured such that when the gaze mark is displayed on the live view window 121e1, the display form (color, shape, size, flashing performed/not performed, and the like) is changed in accordance with display format of the related information relating to the store 313 acquired in the processing at S208.

For example, as shown in FIG. 17A, when the gaze mark has a triangular shape, it indicates that the related information has been acquired in the format of search result list display. As shown FIG. 17B, when the gaze mark is a star shape, it indicates that the related information has been acquired in the format of homepage display.

Note that in the embodiment shown in FIG. 16, the related information relating to the store 314 is not displayed even when a tap operation or the like is performed on a region indicating the store 314. That is, it may be configured such that it is determined whether or not the related information relating to each store is displayable based on existence/absence of gaze mark in the live view window 121e1. Further, when the related information has not been acquired, the gaze mark may not be displayed as described above, however, it may be configured as shown in FIG. 17C such that a gaze mark indicating that there is no related information is displayed.

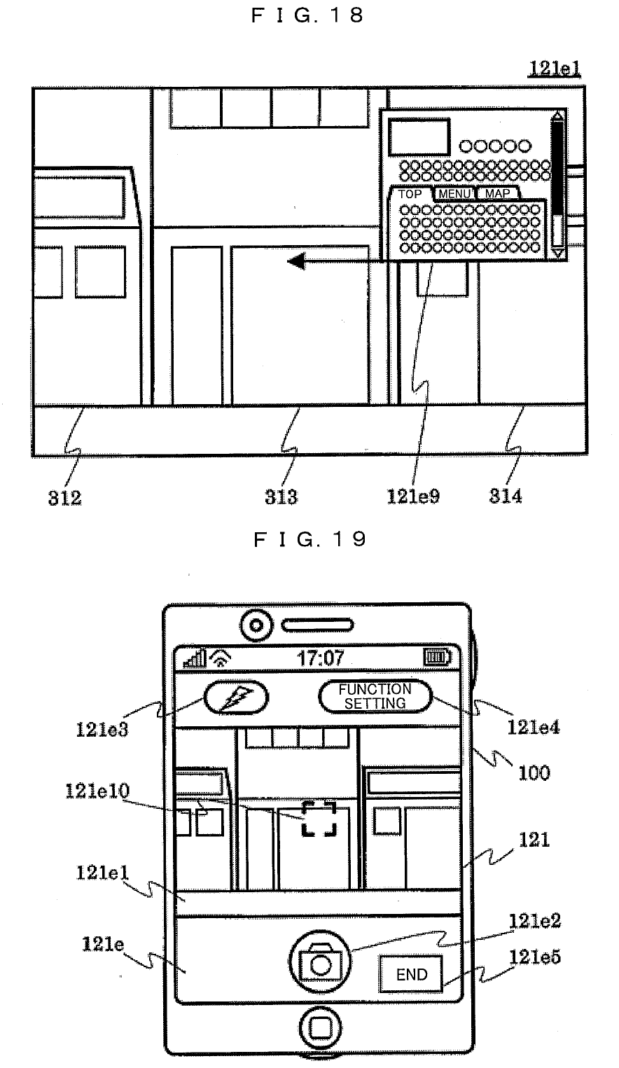

Further, in the processing at S209, it may be configured as shown in FIG. 18 such that a related information display window 121e9 to display the related information relating to a targeted ground object is overlay-displayed in the live view window 121e1 in PinP (Picture in Picture) format. In this case, it may be configured such that when a predetermined region on the touch panel 140t corresponding to the position on the display unit 121, where the related information display window 121e9 is displayed, is selected by a tap operation or the like, the display is changed to the format of the search result list display 121d6 shown in FIG. 10A or the format of the homepage display 121d7 shown in FIG. 10B.

Further, it may be configured such that upon display of the live view display screen 121e, a reference marker 121e10 as shown in FIG. 19 is displayed inside the live view window 121e1. The reference marker 121e10 is a reference position upon focusing processing in the recording sequence upon the user's depression of the “shutter” icon 121e2, and an aiming position upon direction to a target ground object in the information display processing according to the present embodiment. In this manner, it is possible to further facilitate the processing to direct the information display device 100 to the target ground object by displaying the reference marker 121e10 inside the live view window 121e1.

Further, it may be configured such that when the “shutter” icon 121e2 is selected in a status where the related information relating to the targeted ground object is acquired in the processing in the flowchart shown in FIG. 13, in the recording sequence, the specific information and the related information are recorded as extension data, together with image data, in an image data file. Note that the recording destination may be the various information/data recording region of the storage unit 110, or may be various storage medium connected to the extended interface 170, or may be a network storage connected via the communication processing unit 150.

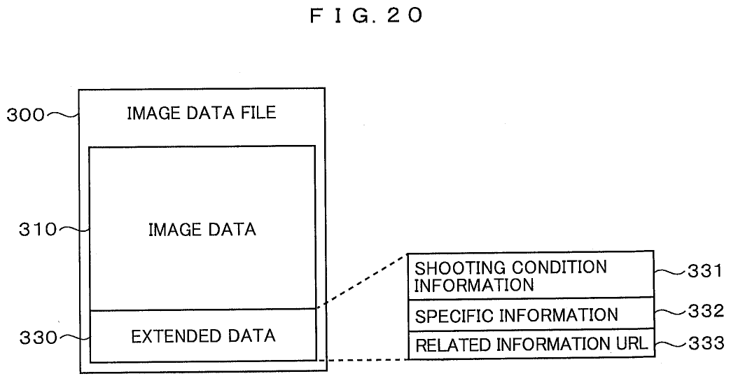

FIG. 20 shows an example of file structure of an image data file 300 recorded in the various information/data recording region of the storage unit 110 or the like. The image data file 300 according to the present embodiment includes image data 310 and extended data 330. In particular, the extended data 330 is formed with shooting condition information 331 indicating shooting conditions such as shooting date and time, the shutter speed, the aperture stop and the like of the image data 310 and GPS information of shooting place, specific information 332 of the targeted ground object acquired in the processing at S207, and a URL (Uniform Resource Locator) 333 of the related information relating to the targeted ground object acquired in the processing at S208.

In this manner, by storing the URL of the related information relating to the targeted ground object acquired in the processing in the flowchart shown in FIG. 13 as extended data of the image data file, associated with the image data, it is possible to re-check the related information of the ground object recorded in the image data upon reviewing the image data at a later date.

Note that in the processing at S203, as in the case of the first embodiment, even when the user's current location has changed and there is a change in the image displayed on the live view window 121e1, it may be determined that the housing attitude has been held for the predetermined or longer period of time as long as the relationship between the user's current location and the particular targeted ground object 313 is approximately constant.

As described above, in the information display device 100 according to the present embodiment, as in the case of the first embodiment, it is possible to acquire and display the related information of the targeted ground object with a more simple configuration without hardware and/or software to acquire distance information between the information display device 100 and the targeted ground object to identify the targeted ground object.

Further, it is possible to display the targeted ground object on the display unit 121 and check it. Further, it is possible to easily check whether or not there is related information relating to the targeted ground object. The related information of the targeted ground object is acquired from a public network such as the Internet by network search with the specific information (address information, store name information, building name information, and the like) of the targeted ground object as keywords. Accordingly, as in the case of the first embodiment, it is possible to efficiently collect latest information. Further, it is possible to store the image of the targeted ground object and the related information relating to the targeted ground object as an image data file into the storage. It is possible to review the targeted ground object and its related information at a later date.

As described above, the examples of embodiments of the present invention have been explained using the first embodiment and the second embodiment. It goes without saying that the constituent elements to realize the technique of the present invention are not limited to the embodiments but various modifications may be made. For example, a part of constituent elements of an embodiment may be replaced with those of another embodiment. Further, constituent elements of an embodiment may be added to those of another embodiment. These all belong to the scope of the present invention. Further, the numerical values, messages and the like in the text and figures are merely examples, and the effects of the present invention are not impaired even when different numerical values and messages are used.

The above functions and the like of the present invention may be realized with hardware by designing a part or all of the functions as e.g. an integrated circuit. Further, they may be realized as software by interpreting a program to realize the respective functions and the like with a microprocessor unit or the like and executing the program. Both of the hardware and software may be used. The software may be previously stored in the ROM 103 or the storage unit 110 of the information display device 100 upon product shipment. After the product shipment, it may be acquired via the LAN communication unit 151, the mobile radiotelephone network communication unit 152 or the like from the application server 211 or the like on the Internet 201. Further, the software stored in a memory card, an optical disc or the like, may be acquired via an extended interface 170 or the like.

Further, the control lines and information lines shown in the figures indicate lines considered as necessary for the sake of explanation, but all the control lines and information lines of the product are not shown. It may be considered that actually almost all the constituent elements are mutually connected.

### REFERENCE SIGNS LIST

100: information display device,

101: main controller,

102: system bus,

103: ROM,

104: RAM,

104a: basic operation execution unit,

104b: information display execution unit,

104b1: location/orientation acquisition execution unit,

104b2: target ground object identification execution unit,

104b3: related information acquisition execution unit, 104c: camera function execution unit,

110: storage unit,

110b: information display program,

110c: camera function program,

120: image processing unit,

121a: basic screen,

121a1: application program icon group,

121a2: ground object information icon,

130: audio processing unit,

140: operation unit,

150: communication processing unit,

160: sensor unit,

161: GPS receiver,

162: gyro sensor,

163: geomagnetic sensor,

170: extended interface,

300: map data,

301 to 302: road,

311 to 315: store,

321: user's current location,

322: azimuth of straight line,

323: straight line,

324: intersection.

1. An information display capable of displaying related information of a target ground object, comprising:
a storage configured to store map information;
a display;
a processor;
a camera; and
a memory storing instructions that, when executed by the processor, cause the processor to:
acquire current location information of the information display,
acquire orientation information of the information display when the information display is directed to a target ground object,
receive image information of the target ground object input from the camera,
identify the target ground object based on the current location information, the orientation information and the map information,
acquire specific information relating to the target ground object,
acquire the related information of the target ground object by search processing based on the specific information,
record a URL information to access the related information of the target ground object in association with the image information, and
display the related information of the target ground object on the display.

2. The information display according to claim 1,
wherein the instructions, when executed by the processor, further cause the processor to:
display a gaze mark, indicating whether the related information of the target ground object is present or absent, overlaid on the image information of the target ground object input from the camera on the display.

3. The information display according to claim 1,
wherein the instructions, when executed by the processor, further cause the processor to:
receive image information of the targeted ground object input from the camera, and
display a gaze mark, indicating whether the related information of the targeted ground object is present or absent, overlaid on the image information of the targeted ground object input from the camera on the display device.

4. The information display device according to claim 3, further comprising:
an input device configured to receive a user operation instruction,
wherein the instructions, when executed by the processor, further cause the processor to:
when the operation instruction to select the gaze mark is received from the input device, display the related information of the targeted ground object on the display device.

5. The information display device according to claim 4, wherein a display form of the gaze mark is different in accordance with a display format of the related information of the targeted ground object displayed on the display device when the operating instruction to select the gaze mark is received from the input device.

6. The information display device according to claim 3, wherein the instructions, when executed by the processor, further cause the processor to:
record an image data file in the storage device,
wherein the image data file includes at least the image information received from the camera and the related information of the targeted ground object.

7. The information display device according to claim 1, wherein the instructions, when executed by the processor, further cause the processor to:
display guidance to hold the information display device toward a direction of the targeted ground object on a ground object information display screen displayed on the display device in an initial state.

8. The information display device according to claim 7, wherein the instructions, when executed by the processor, further cause the processor to:
start processing to acquire the specific information of the targeted ground object when a state where the information display device is directed to the targeted ground object has continued for a predetermined period of time or longer.

9. The information display device according to claim 7, wherein the instructions, when executed by the processor, further cause the processor to:
start processing to acquire the specific information of the targeted ground object upon selection of an information acquisition icon provided in the ground object information display screen displayed on the display device in the initial state.

10. An information display method for an information display device capable of displaying related information of a target ground object,
wherein the information display device has a camera, processor and a storage device configured to store map information, and
wherein the processor executes the information display method comprising the steps of:
acquiring current location information of the information display,
acquiring orientation information of the information display when the information display is directed to a target ground object,
receiving image information of the target ground object input from the camera,
identifying the target ground object based on the current location information, the orientation information and the map information,
acquiring specific information relating to the target ground object,
acquiring the related information of the target ground object by search processing based on the specific information,
recording a URL information to access the related information of the target ground object in association with the image information, and
displaying the related information of the target ground object on the display.
